(19) United States
(12) Patent Application Publication
(10) Pub. No.: US 2010/0254312 A1
(43) Pub. Date: Oct. 7, 2010

(54) DYNAMICALLY TRANSFORMED CHANNEL SET ROUTING

(75) Inventor: Robert A. Kennedy, Frisco, TX (US)

Correspondence Address: MICHAEL J. BUCHENHORNER, 8540 S.W. 83 STREET, MIAMI, FL, 33143, US

(73) Assignee: Adapt4, LLC, Melbourne, FL (US)

(21) Appl. No.: 12/636,338

(22) Filed: Dec. 11, 2009

Related U.S. Application Data
(60) Provisional application No. 61/121,797, filed on Dec. 11, 2008.

(51) Int. Cl. H04W 40/00

(52) U.S. Cl. 370/328

(57) ABSTRACT

A crosslayer routing operation in a network of cognitive radios retrieves routing input parameters from a crosslayer interface, creates additional parameters from retrieved parameters, processes retrieved and additional parameters using a knowledge mapping and reasoning engine, utilizes numeric or linguistic results for targeted routing operations, updates a routing knowledge database; and sends relevant routing information to a route controller.

### CROSS REFERENCE TO RELATED APPLICATIONS

The present invention claims the benefit of U.S. Provisional Application Ser. No. 61/121,797 filed Dec. 11, 2008, by Robert A. Kennedy, entitled “Dynamically Transformed Channel Set Routing,” the disclosure of which is incorporated herein. The following are incorporated herein by reference: U.S. Pat. No. 7,457,295; U.S. Patent Publication No. 20090074033; U.S. patent application Ser. No. 11/532,306; U.S. patent application Ser. No.12/508,952; and U.S. patent application Ser. No. 12/501,921.

### FIELD OF THE INVENTION

The present invention relates to the field of communication networks, and more particularly, to mobile ad hoc wireless networks.

### BACKGROUND OF THE INVENTION

Ad hoc networks are self-forming networks which can operate in the absence of any fixed infrastructure. An ad hoc network may typically include a number of geographically-distributed, potentially mobile units, sometimes referred to as “nodes,” which are wirelessly connected to each other by one or more links such as, for example, radio frequency communication channels. The nodes can communicate with each other over a wireless channel without the support of an infrastructure-based or wired network.

Links or connections between the nodes in the network can change dynamically in an arbitrary manner as nodes move in and out of, or within the ad hoc network. Because the topology of an ad hoc network can change significantly, techniques are needed which can allow the ad hoc network to dynamically adjust to these changes. Due to the lack of a central server-controller, many network-controlling functions can be distributed among the nodes such that the nodes can self-organize and reconfigure in response to spectrum topology changes.

Most traditional radios have their technical characteristics set at the time of manufacture. More recently, radios have been built to self-adapt to one of several preprogrammed radio frequency (RF).environments that might be encountered. Cognitive radios (“CRs”) go beyond preprogrammed settings to operate both in known and unknown wireless channels.

CRs have emerged on the forefront of communications technology for those seeking radios capable of conducting quality communications over decreasingly-available RF spectrum due to many more users requiring larger amounts of spectrum for wireless voice, video and data. A CR determines where in the spectrum it can transmit and receive and where it can spectrally move to in the event it can no longer utilize frequency channels that it has been using due to poor channel quality or to being preempted by a primary user or higher priority secondary user.

Most modern real world applications require at least three CRs communicating with each other to form a wireless network. A cognitive radio so equipped with the ability to initiate and maintain networked communications with other CRs even as each CR is dynamically adjusting the channel(s) it operates on is referred to as a Cognitive Networking Radio (CNR). CNR in general has to do with the radio being fully aware of: 1) who it is, including all of its characteristics (functionality, physical properties and limitations, etc.); and 2) who the users are and their applications and/or missions. CNR involves the radio not only being fully aware of things, but also having a deep enough understanding of the meaning or context of this information in order to allow it to optimize its performance and functionality to satisfy the requirements of the network, applications and users.

It is well-known today that manufacturing a cognitive radio and manufacturing a cognitive networking radio are two very different things. A cognitive radio may be defined as a wireless network node that changes its transmission and reception configuration to avoid interference signals from other users or devices. The cognitive radio monitors its environment within its allotted frequency bands and changes the frequencies or bands over which it operates based on the accessibility to those frequencies. On the other hand, a CNR performs all the functions of a cognitive radio but it also interacts with the networking-specific components and services (routing, quality of service “QoS”, network management, etc.) of both itself and other nodes.

A mobile ad hoc network (MANET) is characterized by the lack of fixed networking infrastructure such as routers, switches, base stations and mobile switching centers in the traditional cellular sense. User nodes (radios) are in general also routers and vice versa. A MANET node is most often battery limited. Also, a MANET's network topology is usually dynamically changing with nodes coming in and going out of the network and with links being established and broken. A node while technically still within the geographic boundaries of the network, may experience a break off in connections to it because of internal node or link failures.

A fully-connected mesh network is one in which there are at least two paths to each node. Partially-connected mesh networks will have some nodes with only one path to it. “Connected” in this case does not have to be limited to each node's nearest one-hop neighbors. It also allows for nodes to be “connected” via multiple hops to all other nodes in the network. Although often used interchangeably in the art, the present application does not define a MANET and a mesh network as one and the same thing. A MANET involves nodes that form a mesh (partial or full), but also may be in motion and have an ad hoc nature or a deterministic or random basis. Although it may be stretching the tolerance of most network engineers, point-to-point, point-to-multipoint and mesh networks (static or mobile) may be thought of as trivial cases of MANETs. As it is now, Bluetooth scatternets are often referred to as ad hoc networks, but again they are just very trivial cases of MANETs. A more detailed description of MANETs and cross-layer communications in MANETs can be found in different documents made available, for example, by the Ubiquitous Internet Research Group through their website (http://cnd.iit.cnr.it/). One such document is entitled “MOBILEMAN, Architecture, Protocols, and Services,” Deliverable D5, by Marco Conti et al. See: http://cnd.iit.cnr.it/mobileMAN/deliverables/MobileMAN_Deliverable_D5.pdf

Routing in any type of highly-mobile network is challenging and MANET represents the most difficult type of general network in which to do routing. The next few paragraphs include a discussion of problems with routing in more traditional networks, problems related to routing MANET over a fixed set of channels, and problems related to MANET routing over a dynamically changing set of channels—“changing” including number of channels, spectral location and width of channels, quality of each channel, accessibility of each channel with reference to security levels, etc.

There are a broad set of prior art MANET techniques for single channel routing that span many different classes of approaches. The Dynamically Transformed Channel Set Routing approach of the present invention (“DTCSR”) moves the development and application of MANET routing into a true multi-channel realm.

Cellular networks may incorporate some peer-to-peer communication, but the real routing is done through a fixed infrastructure of base stations (BS) and mobile switching centers (MSC). One-hop peer-to-peer routing has been introduced recently to improve intra-cell communication among end user devices. This capability off-loads the communications bottlenecks of the hub-and-spoke (base station and end user devices) topology of cellular networks. This capability is also a tacit acknowledgment of the potential of MANET as the ultimate network topology for intra-cell networking.

Primary routing in cellular networks is restricted to a single channel. The conventional cellular system has only one each of uplink and downlink channels. Transmission throughput and transmission power over each channel can change as the link quality conditions change, but there is no attempt to incorporate multiple uplink and downlink channels much less dynamically changing uplink and downlink sets of channels: Peer-to-peer routing in cellular networks has more flexibility in the number of channels used, but generally uses only one of the channels allocated to the cellular network or uses the channel that is currently allocated to a WLAN attached to the cellular network.

Recently, WiFi (802.11a/b/g/n) has become the de facto network of choice for users in local area networks (LANs) such as the network used in coffee shops, malls, convention centers, hotels, bookstores and houses. Each of these flavors of 802.11 is limited to a different universe of channels of which only a single channel can actually be used for any given LAN instantiation. Network topologies may be either the uncommon “ad hoc” (peer-to-peer without an access point) or the normal hub-and-spoke (star) topology that incorporates an access point. Extensions such as 802.11s add a mesh topology (not MANET) and link quality extensions to the MAC, facilitating a degree of mobility among the user nodes. Whatever the topology, 802.11 is still a single channel architecture when instantiated at a given site.

Routing in a WiFi network may be very simple such as in a star network or more complex MANET-like in an 802.11s network with limited mobility. However, the routing cannot operate or even function at all in a multi-channel environment, much less in a dynamically changing multi-channel environment.

There are several specific challenges that any cognitive routing scheme must overcome when the network-enabled devices are of the true dynamically-changing multi-channel cognitive networking radio (“CNR”) nature. Failure to overcome these challenges could result in not just poor network service, but no network service at all. Some of the major challenges are the following.

1. Early loss of the known identity of a node's neighbors. A “neighbor” of a given A/N (association/node—see Definitions section) is defined as another A/N that has at least C number of physical channels that can be established with the given A/N, where C may be up to and include the maximum number of physical RF channels that the radio device is set up to detect.

2. Inability to establish routes since connections are established using multiple, changing channels in lieu of routes using a single channel or a fixed set of channels.

3. Marking an otherwise good route using a given neighbor A/N as “broken” due to the failure of a link on a single channel.

4. Marking an otherwise good route using a given neighbor A/N as “inaccessible” due to Federal Communications Commission (“FCC”) or equivalent international policy, or due to security restrictions on one or more of the open RF channels.

5. How to optimally distribute routing information in the network.

6. Creating multiple user routes from a dynamically changing channel set. Routes would not necessarily be composed of the same number of channels where one or more channels could be shared among more than one route.

7. Identifying candidate channels in the available set of channels at any given time as control channels designed to handle the network control and management traffic. Routing control and management traffic in single channel networks have to deal with sharing the same RF channel as the data traffic. This sharing results in lower user data throughput and delays in identifying routing resources in time to be of use to the A/N set needing to communicate.

8. Determining what knowledge is needed by the routing approach and how to formulate (express) information as knowledge configured into the CNR and flowing through it. This problem has to do with the form of the following types of knowledge such as rules, that govern the base of intelligence associated with the CNR and users.

9. How to reason on the knowledge of 8.

Therefore, there is a need in the art for new routing techniques that address the different problems associated with the use of conventional routing approaches in MANETs or wireless networks.

### SUMMARY OF THE INVENTION

The routing approach of this invention is referred herein as “Dynamically Transformed Channel Set Routing” or DTCSR. DTCSR is the first technology for routing in a cognitive radio (CR) network using the Multi-Association Relay—Spectrum (MARS) concept disclosed in U.S. patent application Ser. No. 12/501,921. The MARS methodology is also fully disclosed herein. In general, DTCSR leverages many routing choices in an environment in which different groups of spectrum channels (channel sets) are available for use on a non-interfering basis from one hop to the next, and potentially along different directions radiating out from a given source.

DTCSR applies to mobile ad hoc networks (MANETs), general mesh networks, point-to-point, point-to-multipoint, wireless local area networks (WLANs) and to sensor networks. In a preferred embodiment, MANET is the default mode of operation. One aspect of the present invention focuses on providing intelligent, mobile (0−N distance units/time) and full/partial mesh connectivity.

The present invention includes systems and methods for improved performance in a wireless network. One embodiment of the present invention enables routing in a cognitive radio (CR) network using MARS as a dynamically-changing “backbone” to carry both user and system-routed traffic across the CR network and to account for locally-changing sets of available channels in which interference with occupied channels is not permitted. The approach and set of mechanisms of this invention form the foundation for routing with cognitive radios in a dynamic network topology, such as MANET. This foundation may be used as presented herein with reference to the preferred embodiments or serve as the basis to develop a family of routing algorithms for use in said radio network environment. More “conventional” MANET approaches provide unworkable routing solutions as they focus on the wrong aspects of a cognitive radio network in which natural environment and many government rules or regulations come into play to affect the operation of the CR and the CNR. Instead, the spectrum-focused approach of the present invention is put forward as the basis to overcome the networking difficulties in a dynamic, cognitive radio-based network.

In one embodiment, the DTCSR network of the present invention implements a route optimization strategy that involves the dynamic collection and distribution of the spectrum topology from what is referred to herein as a MARS set member to other members of a local A/N. A MARS may be elected on the basis of the number of available strict 2-hop neighbor atomic channels from a given source A/N, and does not necessarily rely on the number of strict 2-hop neighbor nodes. A MARS set member may transport all user and most network control traffic throughout the DTCSR network.

This and other objects, features, and advantages in accordance with the present invention are provided in embodiments of the invention by a network and method for managing and controlling routing in the mobile ad hoc network utilizing the resources of a PHY Layer and MAC Layer functionality core framework that allows spectrum sensing-based CRs to form a true multichannel MANET, mesh, point-to-point, point-to-multipoint, WAN, or wireless sensor network (“WSN”) of CNRs while avoiding interfering with primary or higher priority secondary users of the frequency spectrum. The network of CNRs includes a plurality of wireless mobile nodes and a plurality of wireless communication links interconnecting the nodes. One method of the present invention includes determining a set of available channels for every association of nodes or individual nodes in the network for the purpose of routing; executing routing over said available channels; performing true multichannel cross-layer routing; flooding routing traffic through the network over a dynamically-selected subset of nodes and/or associations using an optimized, available channel-based mechanism; performing route discovery, route maintenance, route failure detection and analysis, monitoring and determining true multi-channel route dynamics, performing distributed route control, performing true multi-channel topology discovery, performing neighbor discovery and storing routes in tables and cache.

### BRIEF DESCRIPTION OF THE DRAWINGS

FIG. 1 illustrates one embodiment of a cognitive radio network in accordance with one embodiment of the present invention;

FIG. 2 illustrates a flow chart of the cross-layer routing operation in a cognitive radio network in accordance with one embodiment of the present invention;

FIG. 3 illustrates a flow chart of a route discovery operation in accordance with one embodiment of the present invention;

FIG. 4 illustrates a flow chart of a route failure operation in accordance with one embodiment of the present invention;

FIG. 5 illustrates a flow chart of a topology discovery operation in accordance with one embodiment of the present invention;

FIG. 6 illustrates a schematic diagram of a system component architecture in accordance with one embodiment of the present invention; and

FIG. 7 illustrates a DTCSR system device architecture in accordance with one embodiment of the present invention.

### DESCRIPTION OF THE INVENTION

### Definitions

This section covers definitions of terms or phrases used throughout the present application in describing the embodiments of the present invention. The DETAILED DESCRIPTION OF THE PREFERRED EMBODIMENTS section includes more detailed discussions of at least some of these terms.

Ad hoc associations/nodes (“A/Ns”)—A/Ns may be defined as nodes in an association within an ad hoc network.

Area—An area in a Dynamic Networking Spectrum Reuse Transceiver (“DNSRT”) network (as that network is defined in U.S. patent application Ser. No. 12/501,921) may be defined by a set of physical coordinates (relative or absolute) or by distance metrics around some point, typically radiating.

Association—An association of nodes may be defined as a grouping of network nodes bound together by a specific relationship or set of rules. Associations' relationships or rule sets may be created using any criteria of importance to the user or network. Relationships and rule sets may change over time and therefore so does the nature of the associations they may be applied to. Associations as a whole within other associations may have a specific relationship to other members of the larger association as well as a different relationship common to the members of the smaller association. A multicast group is an exemplary association.

Atomic Channel (AC)—An atomic channel may be defined as the most basic, smallest, operational channel bandwidth of the CNRs in the network. Wider channels used by the CNRs are multiples of this and are formed from assembling multiple ACs. Examples of ACs are 3.125 KHz, 6.25 KHz, 12.5 KHz, 1.0 MHz, 5 MHz, 20 MHz, 1.0 GHz, etc. The notion of an atomic channel also applies to networks in which at least two (2) of the CNRs are capable of simultaneously operating over channels of which not all are of the same bandwidth and in which some channels of these inhomogeneous channel bandwidth CNRs are not multiples of the smallest channel bandwidth of these CNRs. In that situation, distinct, multiple ACs exist in the same physical network as well as in this type of CNR. For example, this inhomogeneous bandwidth is useful where some CNRs are capable of simultaneously communicating over both relatively narrowband and broadband spectrum regions. The CNRs or DNSRTs, as used in embodiments of the present invention, may be part of a network with multiple AC bandwidths.

Available Channel—An available channel is any channel with atomic channel bandwidth that is not occupied at the time of interest by either a primary user or a higher priority secondary user.

Destination—A destination may be defined as a single node or an association.

Dynamic Networking Spectrum Reuse Transceiver—A DNSRT may be defined as a cognitive networking radio with spectrum reuse and spectrum discovery functionality such as that of transceivers disclosed in U.S. Pat. No. 7,457,295 or U.S. Patent Publication No. 20090074033, incorporated herein by reference, and configured to implement a reasoning engine, a MARS election algorithm, and/or a subset of network services.

Frequency-hopping sequence—Frequency-hopping sequence may be defined as the sequence of bits fed into a transmitter or receiver to direct transmission or tuning on a given frequency channel for a given period of time.

Frequency Topology (υT)—The frequency or spectrum topology of a network may be defined as the full set of available frequencies in which some form of allowable RF or wireless communications may occur.
a. Dynamic Frequency Topology (DυT)—DυT may be defined as a frequency topology which changes with time.
b. Heterogeneous Frequency Topology (ρυT)—ρυT may be defined as a frequency topology which changes over a specified physical area of communication for a specified interval of time.
c. Homogeneous Frequency Topology (HυT)—HυT may be defined as a frequency topology which is constant over a specified physical area of communication for a specified interval of time.

“Hopping” or “nodal hopping” may be defined as ad hoc message passing.

Hub—A hub may be defined as the node or association of nodes that is the functional center of some type of activity in the network. In a CNR or DNSRT network, a hub may be responsible for collecting spectrum topology information and disseminating this information to the other nodes in the local spectrum association.

Knowledge Space—When data has been mapped, or transformed, from being of the type useful for numerical processing to forms that are used by reasoning engines to make decisions, then it is said that information has been transformed from data space to knowledge space. An example of knowledge space is the set of fuzzy logic variables and rules that would be used by a fuzzy logic reasoning engine. Another example is the set of extracted feature vectors in a neural network.

Link—a link may be defined as a wireless, true multi-channel interconnection terminated by a node or association on each end of the link.

Maximum Allowable Set (MAS)—The MAS may be defined as the “AND” (intersection) of the number of available channels from each A/N participating in the spectrum discovery process at the time of the request for the determination of the MARS set.

Multi-Association Relay—Spectrum (MARS)—MARS may be defined as a group of nodes, each node in a local A/N within a CNR or DNSRT network, that dynamically collects and distributes the spectrum topology to other members of their local A/Ns. A MARS set member is key to the transport of all user and most network control traffic throughout the network. MARS set members communicate with each other and with other nodes or A/Ns. A MARS set member is elected based on the number of available channels that each of its neighbors has available to communicate with other neighbors.

Multipoint Relay (MPR)—A MPR may be defined as one member of the minimum set of nodes required to reach all two-hop neighbors of a given source node that is flooding the network with network topology information. That is, each MPR is a one-hop neighbor of the flooding source and is chosen to “see” the most two-hop nodes from the source. The strict symmetric one-hop neighbor set of each MPR has zero intersection with all other strict symmetric one-hop neighbor sets of its peer MPR set (i.e., there are nodes in the network that are jointly shared by more than one MPR set). MPR is one optimization of the classical link state flooding process, which in any dynamic topology network would quickly overwhelm the network with overhead traffic from flooding.

Neighbor—A neighbor of an A/N may be defined as that A/N which communicates over one or more available ACs. Physical distance need not be directly involved in the specification of what is a “neighbor” although indirectly, the distance between two associations/nodes may have some bearing on this. However, other things such as policy (e.g., FCC spectrum use policy) may prevent communications over certain spectrum which otherwise would make it free for secondary use.

Network Topology—Network topology may be defined as the interconnection layout of the nodes of a network. The most fundamental type of topology in a wireless network is the set of frequencies (spectrum) that any two nodes/associations may communicate over.

Network Topology Information Base (“NTIB”)—The NTIB of an A/N may be defined as a combination database and knowledge base of information characterizing the association, node and spectrum (channel) network connectivity across the network as known by the given A/N. Included in the information stored in the NTIB may include members of each association (not necessarily an association's internal connectivity among its members), channel sets connecting nodes and associations, etc.

Qualified—This term, as used in this application, may be defined as any quantity such as a set of ACs or topology that meets the networking requirements for whatever set of applications the network is being used. These requirements can be security, QoS, battery, mobility or any other category needed to transport control, management, end user data or other traffic across the network.

Route Segment—A route segment may be defined as any part of an end-to-end (source to destination) route with the segment including of one or more wireless links in which each link is terminated on both ends by either an individual node or association.

Sensor Network—A sensor network may be defined as a plurality of spatially distributed devices that use sensors to monitor physical or environmental conditions in a cooperative fashion. The network interconnections may be wireless.

Strict 2-Hop Neighbor—A strict 2-hop neighbor may be defined as any neighbor of an A/N that is not itself or one of its 1-hop neighbors.

Symmetric Neighbor—A symmetric neighbor may be defined as any neighbor of an A/N that has confirmed or expected bi-directional links between itself and the A/N.

### DETAILED DESCRIPTION OF THE PREFERRED EMBODIMENTS

The methods and systems of the present invention solve the problems associated with conventional routing approaches in wireless networks. For example, to solve the problem of marking an otherwise good route using a given neighbor A/N as “broken” due to the failure of a link on a single channel, DTCSR may mark the route as “degraded” and still keep it in the route table. The true multi-channel capability of the DTCSR does not necessarily mark a route as “broken” because of a single corrupted channel, as a route is truly a multi-channel link in a DTCSR network. Likewise, DTCSR would not necessarily mark a route as “inaccessible”, hence not to be used, just because of a temporary or long term policy block by the FCC on a single channel physically connecting at least two of the A/Ns along the route.

Another problem solved by the present invention pertains to the determination of knowledge needed by the routing approach how to formulate (express) information as knowledge configured into the CNR and flowing through it. In accordance with the present invention, knowledge may be downloaded and stored in the CNR upon initialization of the network and during post-initialization operation. Rules may include known or estimated allowed spectrum regions in which DTCSR could use for routing, capacity/recharge rate/utilization rate under various types of traffic loading or mobility conditions, etc. In addition, real-time event data may be collected and used in decision making at the individual or association levels. Also, outputs from DTCSR may be in the form of knowledge, and not just data, to be used as knowledge inputs for higher level reasoning processes involving the control and management of the whole network. In general, DTCSR's rules may be encoded in the form of crisp (opposite of fuzzy) logic and may or may not have probabilities associated with the rules, with at least some of these rules incorporating temporal information.

In one embodiment of the present invention, MANET routing, including multicasting, is directly supported by the MARS election process described herein. Much of the burden of route discovery is transferred from the routing service to (is subsumed by) the MARS election process, which is a natural part of the spectrum discovery and reuse functionality of the DNSRTs used in one embodiment of the DTCSR network of the present invention. Once a set of MARS A/Ns has been determined and provisioned for any given period of time, traffic can be routed on a hop-by-hop basis. The actual status of routes and the management of them is performed by MANET or mesh routing services and not by the DNSRT. But for optimal performance, a DNSRT device acts as the host of these networking services. The spectrum reuse aspect of the DNSRTs removes much if not all of the next hop discovery overhead of routing.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a machine, such that the instructions, which execute via the processor of the computer or other programmable data processing apparatus, implement the functions specified in the block or blocks.

These computer program instructions may also be stored in a computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer or other programmable apparatus implemented process such that the instructions which execute on the computer or other programmable apparatus provide steps for implementing the functions specified in the flowchart block or blocks.

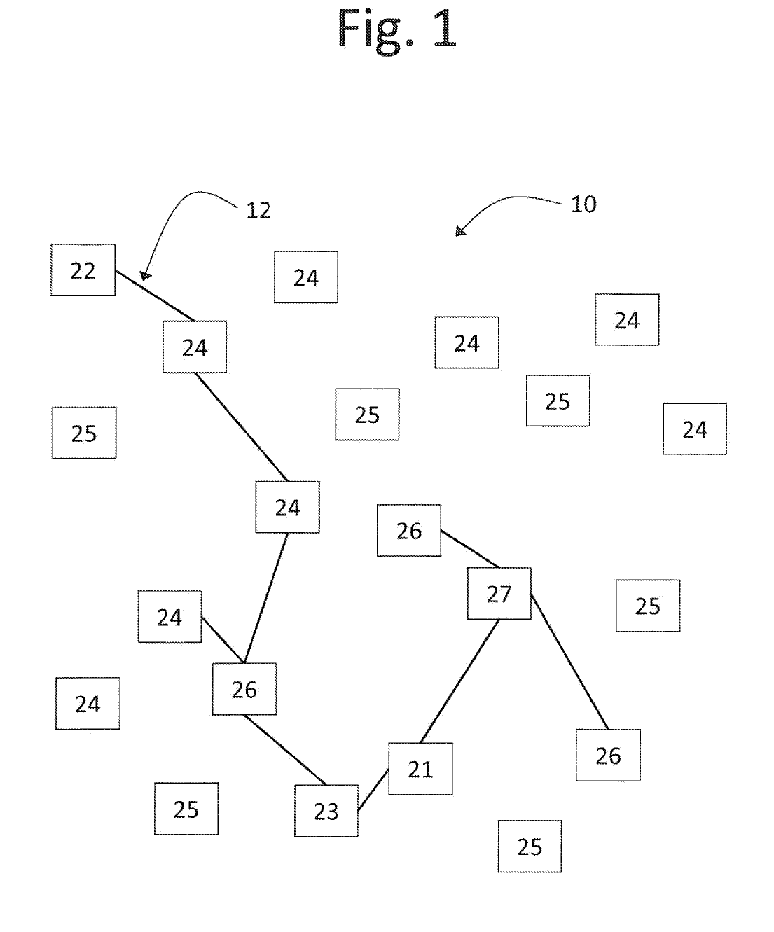

Various entities that comprise a DTCSR network will now be defined. It is to be understood that the term “node” may be replaced by “association” in accordance with this invention without any loss of generality. These nodes are depicted in FIG. 1 in accordance with one embodiment of the present invention. In FIG. 1, the DTCSR network 10 is comprised of several types (e.g., source, destination, MARS elected member, etc.) of nodes 21, 22, 23, 24, 25, 26 and 27. The nodes not interconnected with link 12 are not part of the DTCSR network in any given instance of time (i.e., nodes are constantly coming in and leaving the network), but may join the network.

The source node 21 is the node originating transmissions with the intended communication message. Node 22 is the intended destination of said transmissions. Node 23 is 1-hop distant from the source node 21 and also a member of the current MARS set for the source node 21. Nodes 24 are other nodes in the DTCSR network 10 with no special significance to the DTCSR network 10 except that a subset of these nodes 24 may be intermediate receivers of the transmissions from the source node 21 to the intended destination 22. Nodes 26 are 2-hop neighbors of the source node 21. Nodes 25 are other types of transmitting nodes, possibly primary users or higher priority secondary users in the same spectrum band as 21, 22, 23, 24 and 26 nodes.

Referring now to the embodiment of the invention described in FIG. 1, a method for operating a DTCSR network 10, e.g., by providing a core of network services, will now be described. The network 10 includes a plurality of mobile nodes 21, 22, 23, 24, 25, 26 and 27 including the source node 21 and the destination node 22 with intermediate nodes therebetween. The nodes 23, 24, 25, 26 and 27, such as DTCSR-enabled laptop computers, personal digital assistants (PDAs) or mobile radios, are connected by wireless communication links 12 as would be appreciated by the skilled artisan. In the illustrated embodiment, Node 23 is an elected MARS node for the source node 21 based on its coverage or reachability to 2-hop nodes 26, i.e, based on the number of available channels that each of its neighbors has available to communicate with other neighbors. Node 27 is a non-MARS 1-hop node from the source 21. Nodes 25 are various types of RF sources that must be spectrally avoided by the transmissions from source node 21 or by other DNSRT nodes during the operation of these RF sources. Nodes 25 may or may not be DNSRT-enabled.

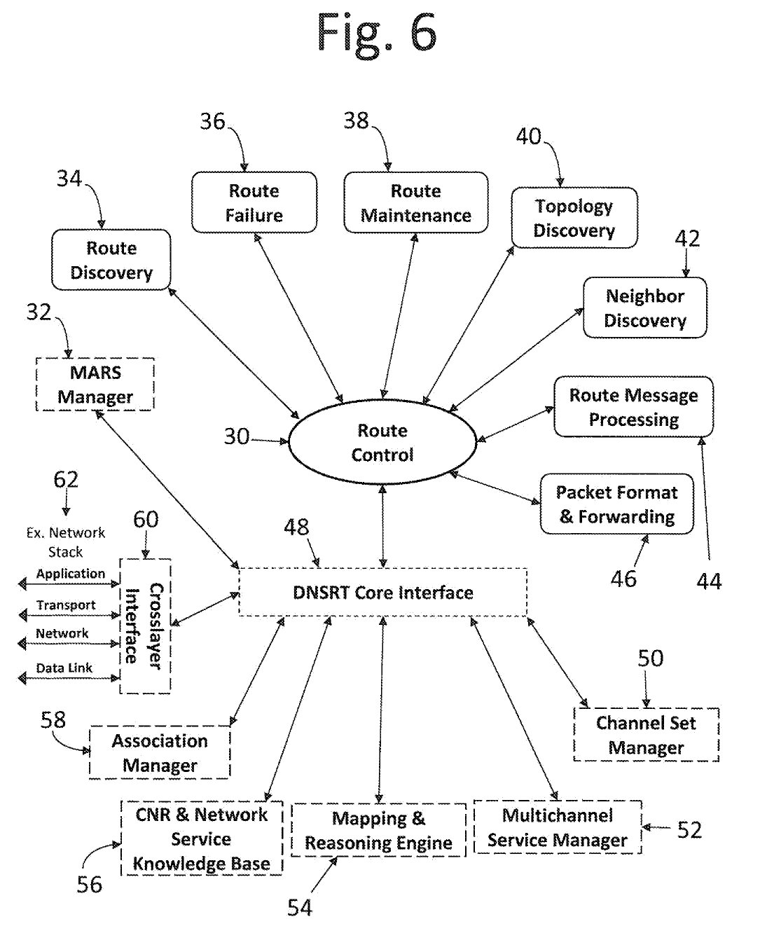

A system aspect of the invention will now be described with further reference to FIGS. 1 and 6. As discussed, the DTCSR network 10 has a plurality of wireless mobile nodes 21, 22, 23, 24, 25, 26 and 27 and a plurality of wireless communication links 12 connecting the nodes together. Each mobile DTCSR node 21, 22, 23, 24, 25, 26 and 27 may include a Routing Controller 30 that controls and coordinates the DTCSR components. Any or all DTCSR nodes 21, 22, 23, 24, 25, 26 and 27 may also include a Route Discovery (DTCSR/RD) component 34 that discovers new routes or uses existing ones from current route tables or route cache when asked that traffic be sent from one A/N to another A/N. DTCSR/RD may also discover new routes when directed by the DTCSR Route Maintenance (DTCSR/RM) component 38. DTCSR/RM maintains discovered routes as needed and reports the status of the maintenance process, including any failure to find a route, without necessarily constituting an explicit operation in DTCSR requiring messages to be sent from one node to another.

The DTCSR Route Failure (DTCSR/RF) component 36 performs route failure detection and analysis to determine if a route has actually failed. In the present invention, a halt in the traffic flow between A/Ns does not necessarily mean that a route has failed.

The DTCSR Topology Discovery (DTCSR/TD) component 40 performs the network topology discovery function. In the DTCSR's topology discovery service the local and global connections throughout the true multichannel topology are central to the topology map.

The DTCSR Routing Control (DTCSR/RC) component 30 directs other DTCSR components. DTCSR/RC is also the primary interface between DTCSR and all other network services in the DTSRT network and other networks. Examples of these services are provided in U.S. patent application Ser. No. 12/501,921. The Neighbor Discovery component 42 is used by the Topology Discovery component 40 to determine the set of N1s (one-hop neighbors) for any given A/N. The Packet Format and Forwarding component 46 includes the various types of packet and message formats including the basic header preceding any type of DTCSR message. The forwarding part of this function uses both standard IP forwarding mechanisms as well as the dynamic MARS backbone. The Route Message Processing component 44 may reside in each DTCSR A/N and is responsible for directly parsing and interpreting each DTCSR message and then sending that message to the targeted DTCSR component(s).

Besides the DTCSR core components 30, 34, 36, 38, 40, 42, 44 and 46, DTCSR also utilizes several DNSRT core functions and services shown as dashed rectangles in FIG. 6. The DNSRT functions and services are more fully described in U.S. patent application Ser. No. 12/501/921. Communication between DTCSR and the DNSRT core functions and services may be performed through the DNSRT Core Interface 48.

A MARS Manager 32 controls and manages the MARS election and signaling process and any subsequent modifications of a given MARS set. MARS Election and Signaling is the process for optimizing the dissemination of any type of user and network control/management traffic within a DNSRT/DTCSR network. The election part of this function is the process for adding A/Ns to the MARS set of the DNSRT network.

A Crosslayer Interface 60 provides the Routing Controller 30 with access to whatever network stack 62 is present with said network stack 62 and also outside of the DNSRT/DTCSR core. A Multichannel Service Manager 52 distributes any given DNSRT network service across the available local channel set. A Channel Set Manager 50 manages and controls the contents of any given local channel set. A Reasoning Engine 54 accepts inputs coded into such forms as crisp or fuzzy logic, temporal data, etc. and reasons on these inputs over the CNR & Network Service Knowledge Base 56. A CNR & Network Service Knowledge Base 56 contains both CNR device information and specific DNSRT network service information in the forms of pure data and knowledge coded in such forms as IF-THEN rules or temporally-coded data. An Association Manager 58 manages and controls the contents of local associations.

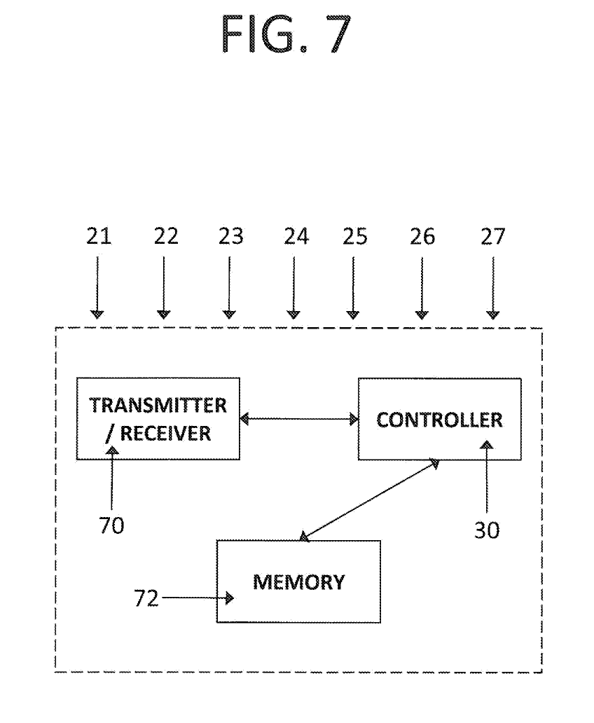

A system aspect of the invention will now be further described with reference to FIGS. 1 and 7. As discussed, the DTCSR network 10 has a plurality of wireless mobile nodes 21, 22, 23, 24, 25, 26 and 27 and a plurality of wireless communication links 12 connecting the nodes together. Each DTCSR-enabled mobile node 21, 22, 23, 24, 25, 26 and 27 may include a controller 30 that has a communications device 70 to wirelessly communicate with other nodes of the plurality of DNSRT nodes via the wireless communication links 12. Also, a memory 72 may be included as part of the controller 30 or in connection with the controller.

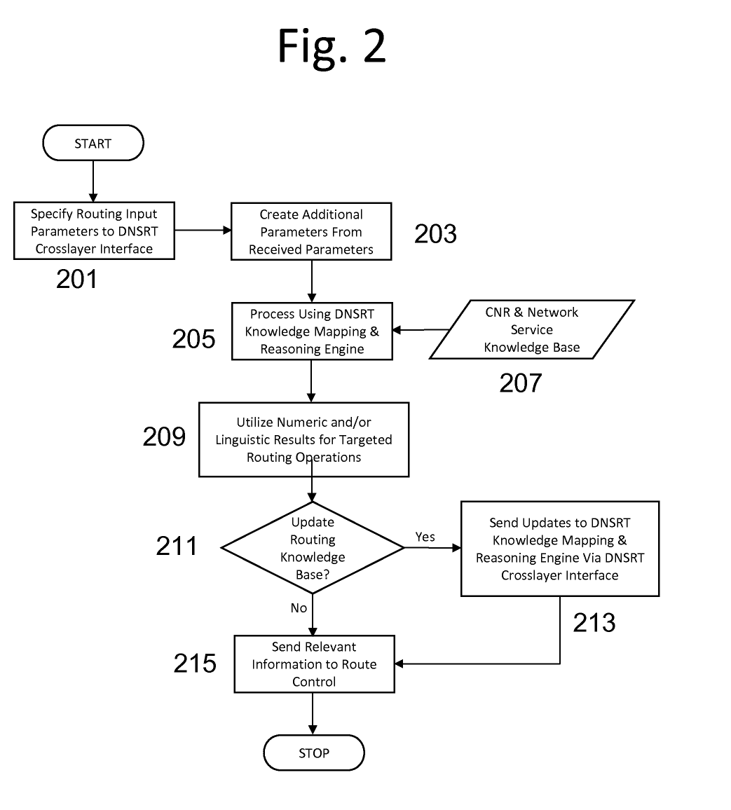

A system aspect of this invention will now be further described with reference to FIGS. 1 and 2. Within the DTCSR-enabled mobile nodes 21, 22, 23, 24, 25, 26 and 27 that include a controller 30, routing occurs using information from any network stack layer including layers adjacent and non-adjacent to that layer or layers in which any given routing function in DTCSR resides. Said adjacency and non-adjacency is also extended to other mobile nodes 21, 22, 23, 24, 25, 26 and 27 in which the information needed by any given routing function resides. In DTCSR, cross-layer routing includes not only adjacent and non-adjacent network stack layers within a given node, but also adjacent and non-adjacent network stack layers between nodes. Said cross-layer routing also applies to associations such that “association” can be substituted for “node” for all or a subset of A/Ns in a DTCSR network.

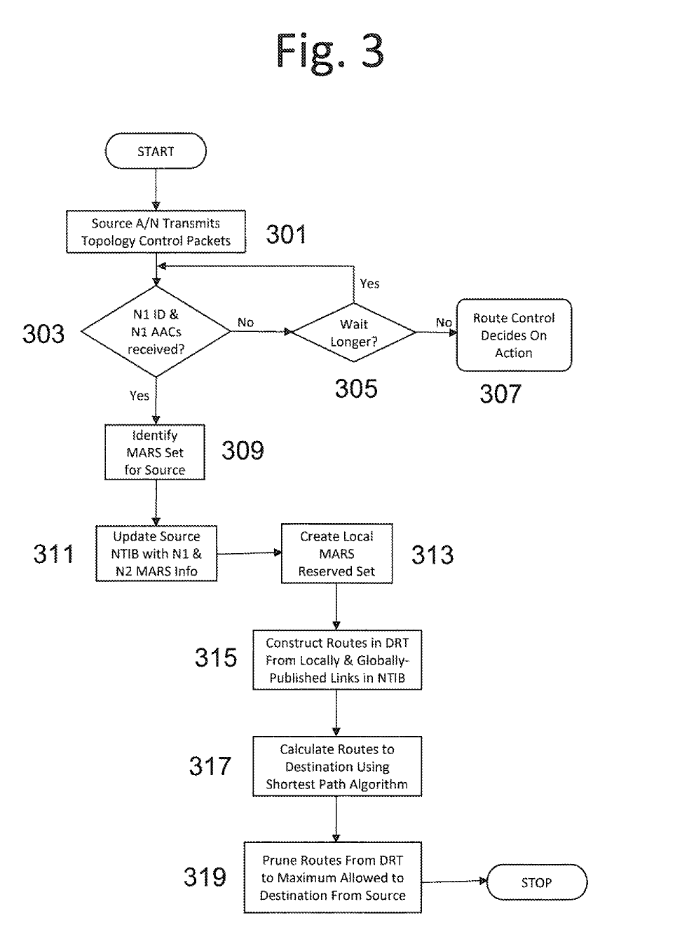

A system aspect of this invention will now be further described with reference to FIGS. 1 and 3. Route Discovery may be performed by each DTCSR-enabled mobile node 21, 22, 23, 24, 25, 26 and 27 that includes a controller 30 in which a given node is configured and directed to do so (authorized). DTCSR/RD depends on each A/N performing timely local neighbor (N1) discovery and responding to any N1 A/N with its ID and AAC set when the A/N receives a topology control packet 301 from some given source A/N requiring such information 303. Routing Control 30 takes over when the normal request-response cycle 301, 303, 305 has exhausted itself for the given request. Since routing is performed primarily over the current MARS set (“backbone”) 309, DTCSR/RD interacts with the ongoing MARS updating process 311 to get the N1 and N2 MARS information. From this collection of MARS information, a subset of the MARS local (N1 and N2) set is reserved 313 over which to route traffic requiring special conditions. Special conditions for this reserved MARS set could come from network security, QoS, billing costs or other criteria. Each source then constructs routes 315, 317 in its DNSRT route table/cache from the information contained in the source's Network Topology Information Base that in turn is built from received topology updates.

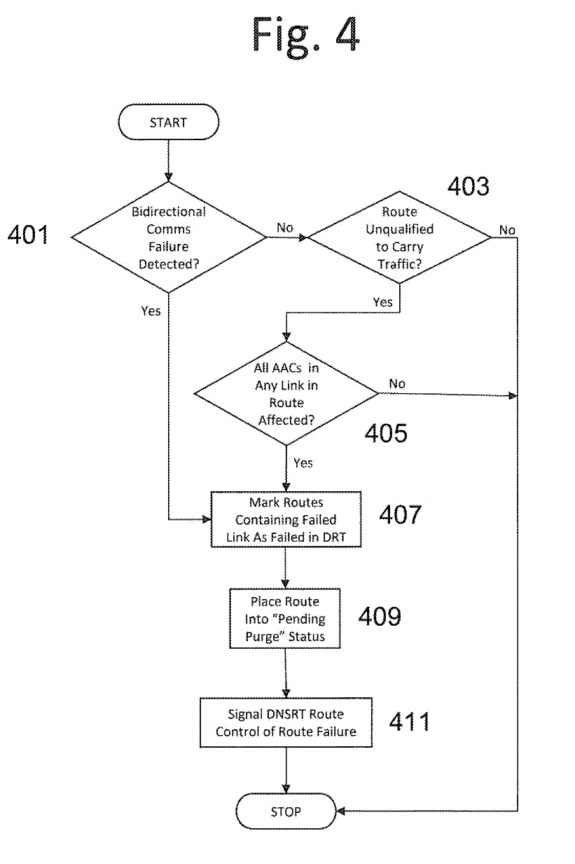

A system aspect of this invention will now be further described with reference to FIGS. 1 and 4. The Route Failure function may performed by each DTCSR-enabled mobile node 21, 22, 23, 24, 25, 26 and 27 that includes a controller 30 in which a given node is configured and directed to do so (authorized). As previously mentioned, DTCSR/RF is composed of both a route failure detection component and a route failure analysis component. When the source or an intermediate node in a route detects the failure of bidirectional communications between it and any of its one-hop neighbors 401 or detects/is informed that any of the route segments in a route in the given source/intermediate node is no longer qualified to carry traffic despite bidirectional communications still being active, then one of two actions may take place 403. If the route is unqualified, then a check is made to determine if all AACs in any “failed” link has been negatively affected 405. If not, then the route is not marked as “FAILED” 407. Although the route may be not fully qualified to carry given traffic, it is nonetheless may still be able to carry traffic in a degraded mode. On the other hand, if either bidirectional communications has failed and/or all AACs in any link in a given route are negatively affected, then the node marks all the routes in its route table/cache containing the failed link(s) as “FAILED” and places the failed route into a “PURGE” status 409. The purging is not required to take place at this time and may not occur at all. DTCSR/RF notifies Routing Control (DTCSR/RC) 411 which then determines what action to take in response to the failed route and when and if to do execute the action. For example, DTCSR/RC may prevent the natural Topology Discovery (DTCSR/TD) and NTIB updates from removing the route even though it is technically gone for the time. The DTCSR/RC may also allow DTCSR/TD to purge such failed routes from the target route table/cache.

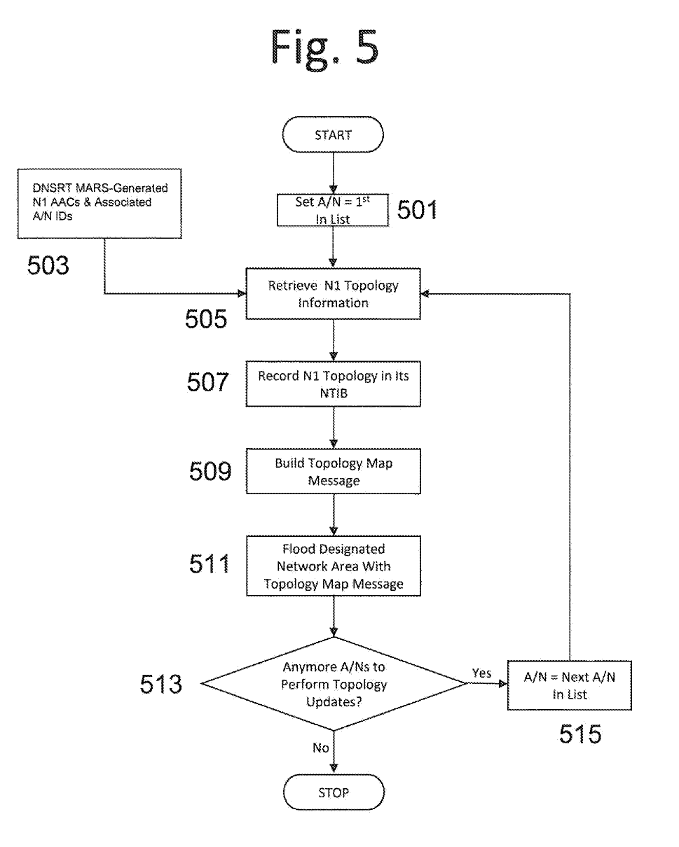

A system aspect of this invention will now be further described with reference to FIGS. 1 and 5. Topology discovery may be performed by each DTCSR-enabled mobile node 21, 22, 23, 24, 25, 26 and 27 that includes a controller 30 in which a given node is configured and directed to do so (authorized). Each of said nodes 21, 22, 23, 24, 25, 26, and 27 may record its N1 topology in its Network Topology Information Base (NTIB) 507. Each node may also flood the network (e.g., by limited flooding) with a Topology Map (TM) message when requested or on a periodic basis 511. The TM formed may contain a Neighbor Topology Sequence Number (NTSN) and an ID for each of its neighbors. The purpose of the NTSN is to ensure that only the TM with the latest NTSN is used to create or update the node's topology map 513. DTCSR/TD utilizes the N1 multichannel spectrum sensing and A/N ID information obtained from the PHY or MAC Layers of CNRs to create a set of N1s for a given A/N 503. Topology Control messages are then created 509 using the given node's MARS electorate, non-electorate neighbors and other published neighbor information. Information for each neighbor includes at least the neighbor ID.

Each neighbor may also include the AAC list for the given node. Each message contains this information in addition to control information included in each message. One type of control information included is a sequence number for the set of information being published by the node. Another type of control information included in each packet is a “Time-to-Live” for the topology being published in the packet. Time-to-Live may be specified as number of hops or as an actual clock time which is globally synchronized across the DNSRT network including any external networks accessing this information. Time-to-Live may also be specified as a relative time to being received by the node. In one embodment, a separate two-bit control field in the topology message header set by the originator of the topology message determines how the Time-to-Live field is to be interpreted by any node receiving it. In one embodiment, nodes receiving any topology message do not process aged information and do not pass it on to other nodes. Using the MARS backbone topology, these topology message packets may be disseminated across the DNSRT network. These packets may also be encapsulated in TCP or UDP packets for transport within a local IP network. These packets may also be routed to a local gateway for connection to an external network using a given internetworking scheme. Thus, the DTCSR topology information can be made available to authorized users outside of a DTCSR network. Each node (internal or external) may build and update its own Network Topology Information Base (NTIB) from the topology messages that it receives.

Neighbor discovery may be performed by each DTCSR-enabled mobile node 21, 22, 23, 24, 25, 26 and 27 that includes a controller 30 in which given node is configured and directed to do so (authorized). The N1 and N2 neighbor lists including associated IDs and AACs are made available to any DTCSR function needing them. This includes the development of the MARS set (a DNSRT function) and Topology Discovery. The controller 30 may interact with each DTCSR function to ensure the coordination that neighbor updates are timely and up-to-date.

Performing route maintenance in DTCSR involves a combination of the normal operations of topology discovery, neighbor discovery and route discovery. Therefore, should an existing route fail as a result of link or A/N failure, the routing process will automatically find another available route if currently available, in the source's A/N route table/cache or else wait until the next topology discovery cycle to determine if any routes are added to the route table/cache that supply the route between said source A/N and the destination. The NTIB is automatically updated as changes in the local topologies of A/Ns change that could cause a change to the route table/cache of the source A/N. Naturally-functioning aspects of the neighbor discovery and route failure components include repairing routes by increasing transmission power on a link to overcome a low signal-to-noise (“SNR”) problem to discover some minimum set of neighbors, or allocating additional channels on a link to reduce route failure are.

Core Functionality

The core functionality of DTCSR includes the following:
Route Discovery
Route Maintenance
Route Failure
Route Control
Topology Discovery
Neighbor discovery
Packet format and forwarding
MARS election and signaling
Messages

Packet Format and Forwarding

The general packet format for DTCSR may adopt the general packet format for any DNSRT service. This packet format includes a common header followed by one or more messages embedded in the data portion of the packet. These packets in turn can be embedded in UDP or IP datagrams and transported through the network or across networks as directed. The following definitions identify fields that may be included in the packet header:

Packet Length—Number of bytes in the entire packet including the payload (message).

Packet Sequence Number—Integer quantity that is incremented by one each time a packet is transmitted.

Service Type—Integer quantity representing the DNSRT service (Routing, QoS, Security, Network Management, Mobility Management, etc.)

The next set of definitions identify fields included in the message header that may be attached to the packet header:

Message Type—Integer that contains the numerical message type.

LTime—Lifetime of the message after reception by an A/N. Messages floating around the network or being stored/used onboard the radio after this time may be referred to as “Zombies” and should be removed from the network.

Message Size—Number of bytes in the actual message not including the message header, which may be fixed in size.

Source Address—This is the address of the A/N originating the message, not the intermediate addresses along the route such as found in the IP header.

Time To Live—The maximum number of hops that a message may be retransmitted. The count is decremented by 1 each time that it is retransmitted. At a count of 0, it is no longer retransmitted and is either held by that A/N for further instructions or processing or else is deleted according to the “End of Life Action.”

End of Life Action—The action to be taken by the resting place (where its Time To Live=0) of the message. Actions may include “Delete and “Hold”.

Hop Count—The number of hops a message has taken. This count is incremented by 1 before each transmission, but that count is then decremented by 1 if the message is for some reason unable to be sent.

Message Sequence Number (MSN)—This is a unique integer ID attached to each message sent by the originating source A/N of the message. Each new message sent by this same A/N has an MSN that is one greater than the previous message transmitted by this A/N. This prevents the same message from being first transmitted by the A/N, then receiving its own message after taking some circular path back to the originating A/N and then retransmitting the same message. If the same message has to be retransmitted due to it being dropped or corrupted for some reason, then a clone of the same message may be sent from the originating A/N, but with a new MSN. The value of the new MSN is greater than the previous transmission of this message, but will take on whatever is the next integer ID depending on how many other new messages were transmitted by this A/N between the previous and current clone of the message.

Messages

This section provides an overview of the basic messages in DTCSR. DTCSR messages are attached to the general DTCSR header for transport across the DNSRT network. Currently-specified messages are discussed. The list of DTCSR messages is as follows with the message type in parenthesis ( ).
Initialize Routing (1)
Update Topology (2)
Your Topology (3)
Create Report (4)
Startup (5)
Shutdown (6)
Restart (7)
Mute (8)
Unmute (9)

Messages may be distributed to any part of the network up to and including the entire network. Using internetworking functionality, DTCSR messages may even be transported across networks.

Initialize Routing (ID, RTbl, NTIB)

The Initialize Routing (IR) message instructs the target A/N to initialize its route table, Network Topology Information Base (NTIB) and other parameters as directed by the message parameters. The ID may be the IP address, physical address, or other network-wide agreed to address of the target A/N. Linguistic names may be used as the ID as long as they map to known IP or physical addresses that the network understands.

Update Topology (ID, TD_Method)

The target A/N (specified by ID) is explicitly instructed by DTCSR/RT to (1) perform a topology discovery operation out of its normal time sequence, (2) be given the topology it is to use in the next “Your Topology” message that the A/N receives, or (3) have its NTIB updated by both avenues. If “Both” is selected, then the A/N does not need to perform a topology discovery operation until after receiving the “Your Topology” message. “TD_Method” specifies the topology update method.

Informing another A/N about its topology serves different purposes. In one aspect of the present invention, only a subset of the target A/N's topology could be given to it so that certain N1s, N2s and AACs are placed into a reserved or “do not go here” status. In another aspect of the present invention, the target A/N is infomed what N1s, N2s and AACs it may use from the point of reception of this message by the target A/N until the next topology update. The next topology update may come either by dictate through a message or by the A/N going through its normal topology discovery operation. In still another aspect of the present invention, by dictating the topology to an A/N, overhead may be saved when the self topology discovery operation is explicitly executed by the A/N. Whether overhead is saved depends on several factors such as computation and bandwidth usage by the A/N. Metrics may be collected by the DTCSR/RT for A/Ns and published for other network A/Ns to collect and analyze to determine whether or not such overhead would likely be saved.

Your Topology (ID, NTIB)

This message pushes a network topology view contained in the NTIB onto the target A/N specified by ID.

Create Report (ID, Type, Report)

Create Report instructs the target A/N (ID) to produce and publish a report (Report) of the given type (Type). Uses for reports may include operational status and billing.

Startup (ID, NetMode)

Instructs a target A/N (ID) to start normal networking operations at the A/N according to the NetMode value. Some important allowed values for NetMode are {Basic, MANET, General Mesh} where Basic is used to place the A/N into a point-to- point or point-to-multipoint mode depending on the allowed connectivity for the target A/N. Mobility is handled automatically by DTCSR as mobility is assumed to be ≧0 (distance units/time unit). A Startup command can optinally be run after a Shutdown or Initialize operation.

Shutdown (ID)

This shuts off all networked communications of the target A/N (ID), but not the A/N's transmitter or receiver.

Mute (ID, Level)

This command instructs the target A/N (ID) to turn off or to substantially reduce the power of its transmitter, but not to turn off its receiver. In one embodiment, if Level is set to 0, the the transmitter is turned off; and if Level is set to 1, power is reduced to a very low level below the radio's neighbor discovery signal level.

UnMute (ID, Level)

This command instructs the target A/N (ID) to return its transmitter to an operating power level after having it muted. In one embodiment, if “Level” is set to 1, then the CNR is powered to only the default normal operating setting; and if “Level” is set to 2, then power is returned to the previous power level set when it was muted.

Multi-Association Relay—Spectrum (MARS) Election and Signaling

One of the major distinctions of DTCSR from any other MANET routing technique is its dependence on the MARS concept first introduced in U.S. patent application Ser. No. 12/501,921. Another major distinction is DTCSR's native ability to fully execute on a true multichannel wireless network. Some other MANET routing techniques such as the Optimal Link State Routing (OLSR) utilize use a concept called Multi-Point Relay (MPR). MARS and MPR are both network traffic flooding optimization strategies. However, they are considerably different in how they function and how they are elected for their roles in a dynamic network. A MPR is elected on the basis of the number of strict two-hop neighbors from the given source node. A MARS is elected on the basis of the number of available strict 2-hop neighbor atomic channels from the given source A/N, not the number of strict 2-hop neighbor nodes—a fundamentally different criterion with fundamentally different impacts on network decisions.

The MARS “backbone” that is created and dynamically updated optimally floods (distributes) any type of network traffic across the network. This includes all user messages to be flooded as well as network control and management messages. Additionally, all peer-to-peer user traffic is transported over routes composed of MARS A/Ns except possibly the source and/or destination.

The MARS Election Process

MARS is not unique to DTCSR, but is a fundamental part of DNSRT. The MARS default election process is reiterated here. DNSRT may support other MARS election processes if needed. N1 and N2 are abbreviations for 1-hop and 2-hop neighbors respectively. S0 is the source A/N that originates the traffic flow.

1. Set S=S0.

2. S broadcasts a preamble to discover the available ACs in its 1-hop neighborhood.

3. S performs an ANDing operation on the set of available ACs from itself and each of its candidate spectrum N1s to obtain the common set of N1 ACs.
a. The resultant set of available ACs is recorded by S. These are the ACs used by S to send data and other information to its N1s.

4. If the qualified number of available ACs is sufficient to meet S's traffic requirements, go to step 6. If not, then S has three options. (An available AC is “qualified” based upon other requirements that may be placed upon communication such as QoS metrics, security restrictions, cost to use ($), etc.)
a. Use the number of ACs under degraded communications conditions
b. Try again later and go to Step 2
c. Reduce transmission power and immediately probe its 1-hop neighborhood. This action is undertaken to find a common set by reducing the number of emitters that must be avoided for the time of transmission. The power reduction factor is left to the designer to choose and may be derived through any means, e.g., heuristic, analytical, simulation, etc. These three options do not have to be carried out in any particular order. The systems designer may decide the order of carrying these out, or which ones to carry out at all.

5. If one of the above three options is successful, then the process will reach Step 6. If not, then go to Step 2 or send an error message to S's controller (system choice).
a. If S's controller receives this error message, the controller decides whether to try again later or take other action. The other action may simply be selecting another route discovery method.

6. Having identified the N1 ACs that it will use, S then broadcasts to those N1 A/Ns a request and a preamble to discover the available N2 ACs for each N1 of S.

7. In parallel, each N1 executes the following steps.
a. N1 broadcasts a preamble to each of the strict N2s of S to discover the available ACs of all of the strict N2s of S within RF visibility of the given N1.
b. N1 performs an ANDing operation on the set of available ACs from itself and each of its candidate spectrum N2s to obtain the common set of ACs for this N1.
   i. The resultant set of available ACs is recorded by S.

8. S then starts with the N1 that contains the largest number of available N2 ACs and eliminates redundant available N2 ACs in the other N1 sets.

9. Step 8 is repeated for each of the other N1s starting with the N1 with the second largest number of available N2 ACs and eliminating redundant available N2 ACs in the other N1 sets with equal or smaller numbers of available N2 ACs.

10. The MARS set consists of all the N1s with a non-zero count of available N2 ACs that they can access.

11. If the qualified number of available ACs is sufficient to meet S's traffic requirements (for example, the number of messages of a given type per second, or the number of packets per second), go to step 15. If not, then S has two options. (An available AC is “qualified” based upon other requirements that may be placed upon communication such as QoS metrics, security restrictions, cost to use ($), etc.)
a. Use the number of ACs under degraded communications conditions
b. Try again later and go to Step 7.

These two options do not have to be carried out in any particular order. The systems designer may decide the order of carrying these out.

12. If one of the above two options is successful, the process continues with Step 13. If not, then go to Step 7 or send an error message to S's controller (system choice).
a. If S's controller receives this error message, the controller decides whether to try again later or take other action. The other action may simply be selecting another route discovery method.

13. The selected N1s are now designated by S as elected MARS members.

14. Having identified its MARS members, S then broadcasts its user and systems traffic with the next-hop destinations being the MARS members. Non-MARS members of S will not forward any traffic even though they may receive it from its neighbors.

15. All of these steps are repeated at either regular or irregular intervals while the network is functioning.

16. Set S=S0+ij where ij is the jth member of the set of ith neighbors of S0. Thus, after the first set of MARS members is elected, the next set of MARS members comes from using the N1 MARS members as the “S” members from which to begin the election process for the MARS members one-hop further out than the current set of MARS members.

17. If one of the N1s of the current Sij=D (the destination of the communications), then STOP. If not, then repeat Steps 2-16 for each member of the current set of S A/Ns/nodes.

18. Repeat Step 17 for each current S A/N.

Notice that in the above MARS election process, if the entire network was frozen and a snapshot taken, the N1 and N2 sets would be seen as moving outward from the originating source. In other words, some A/Ns that are N2s in relation to a given set of N1s, would be the N1s in relation to another set of N2s further in hops from S0. At least one outward path will converge at the intended destination with the network minimizing the number of A/Ns with access to a maximum pool of ACs. The main pitfall in just looking at this analysis too simplistically is that the topology of the network is in general very dynamic. A/Ns that were once the N1s in relation to a set of N2s, might later in the evolution of the network switch roles where a given (N1, N2) pair would look like (N2→N1, N1→N2).

All other things being equal, choosing the largest set of qualified available atomic channels in the band(s) that radio devices are operating in for every MARS A/N will ensure the highest probability of traffic flow with the desired QoS from the source to the destination.

Route Discovery

DTCSR/RD uses a proactive mechanism for route discovery based on topology discovery and the previously-discussed dynamic MARS “backbone”. That is, known routes from a given source node or source association to every destination node or destination association is stored in the route table for the A/N. One advantage of an association is that the routing table in effect for all members of the association is stored in the current leader node set of the association. This further allows routing and storage optimizations in the network. As in most next-hop routing methods as opposed to source routing methods, no other intermediate A/Ns are included as part of the route table entry. In the present invention, entries in any route table may take the following form.

Route Table Entry: {best; NxHop; ANxH; AACs; EDD; Access; Reserved}

Destination (Dest) may be defined as the A/N ID of a destination reachable at the time of discovery from the originating A/N. Next Hop (NxH) may be defined as the primary N1 of the originating A/N to begin sending the packets. The Number of AACs to the next hop (ANxH) may be defined as the number of AACs associated with the link from the originating A/N to the NxH. AACs to the next hop may be defined as the subset of ACCs taken from the full set of N1 AACs used to construct the link from the originating A/N to its next hop. Estimated Distance to Destination (EDD) may be defined as the estimate from the originating A/N to the Destination where distance may be defined as whatever metric (number of hops, QoS metrics, available battery life, etc.) is chosen for this particular traffic. Access may be defined as the accessibility of the NxH link or A/N. Reserved may be used to expand the types of information stored in the route table as needed.

In one embodiment, the default for Access is ALWAYS, which means that there are no security restrictions or any other type of restrictions placed on it. While additional optional fields may be included in the route table entries, each additional field requires storage and processing by the local A/N.

The actual calculation of routes may be performed as part of the DTCSR/RD component's functionality. Each A/N may be tasked with the responsibility to publish its links between itself and at least its MARS electorate.

DTCSR allows multiple routes to be simultaneously multiplexed on a single transmission along the link by allocating different subsets of the AACs along the link to different routes. The DTCSR/RC controls and manages this operation. The ability to accomplish this ultimately depends on the ability of the PHY Layer (radio, modulation scheme, etc.) to carry out the direction from Route Control in real-time.

The following route discovery algorithm, implemented in one embodiment of the invention, executes the ordered set of steps for each A/N:

1. A/Ns send out Topology Control (TC) update packets to get both the N1 IDs and the N1 AACs

2. MARS A/Ns are identified using the MARS election and signaling processes

3. The originating A/N NTIB is updated with the N1 MARS set and each N1 MARS node's N2 ID in addition to its AACs

4. A “reserved” MARS set is formed by adding N1s and N2s to the originator's MARS set that have specific characteristics desirable by the users
a. The goal is to set up essentially a VPN within the DNSRT network

5. Routes are constructed from information in the NTIB using the links with their N1s and N2s in addition to links published by more distant A/Ns to other destinations

6. Other than the final link to the destination A/N, members of the source A/N's MARS N1 set with the desired destination may constitute the entries transferred from the NTIB to the DTCSR Route Table (DRT) of the source

7. One or more routes are then calculated to the destination using a shortest path algorithm such as Dijkstra or A*
a. Dijkstra may be defined as the default if the network developer does not specify an alternative
b. The “shortest path” in DTCSR may be defined as that route in which the sum of the weighted links from the source to the destination is minimized
c. Link weight may be determined by combining a set of cost criteria

1. For example, security privileges, QoS metrics (including number of hops), robustness, billing costs, persistence of the AACs, etc.

8. Routes that do not satisfy the number to be kept from a given source to a given destination are pruned from the DRT

For purposes of route calculation, DTCSR may consider each A/N as being not just a vertex in a graph, but actually a special type of link. Thus, shortest path algorithms should include both nodes and associations in the shortest path calculations. For example, traversing an association of nodes may cause a bandwidth reduction or a significant time loss if particular types of traffic require certain nodes within the association to process the traffic before the association releases it for transmittal to the next hop in the route. Data compression/decompression, encryption/decryption, intermediate storing into a node database, and retrieval of information from a node's database with subsequent tagging onto the data stream are but some examples of reasons to consider a node or association as a link in its own right for purposes of shortest path calculations.

Route Maintenance

Route maintenance, a more involved operation in reactive routing, is not necessarily an explicit operation in a proactive routing approach such as DTCSR. DTCSR/RM may be inherently performed as a routine part of the combination of the topology discovery, neighbor discovery and route discovery processes. The DTCSR routing table of a A/N does not need to be recalculated unless the NTIB of the A/N is changed. No messages are sent or received, nor are any needed to update the local A/N route table for route maintenance purposes. This has the advantage of maintaining rapid, normal topology discovery and route discovery operations. The control of how often or when to do topology updates and route recalculations depend on instructions from the DTCSR route controller.

Route Failure

DTCSR/RF may be detected when there is no longer any bidirectional communications between two A/Ns in a route in the source's route table. Route failure also occurs when DTCSR/RF is infrmed that the route is no longer qualified to carry traffic for reasons such as security or priority access changes or government policy changes. If this happens for all AACs along any part of the route, then the route is placed into a “pending purge” condition. This condition signals to DTCSR/RC that unless it is otherwise instructed, the route is not to be used to carry traffic and the route will be purged from the A/N's route table at the next scheduled periodic topology update. Of course, the route will not be purged at the next topology update should bidirectional communications be discovered to have been reestablished.

Normally, it would be expected that such policy changes be known before the network goes into operation. The present invention allows for the possibility of policy changes occurring after the network is in operation, for example in an emergency situation.

An established route is considered “good” even if the set of AACs changes on any link in the route. What this means to DNSRT is that while there may be less bandwidth available than shortly before the latest topology update, there is nevertheless some bandwidth. It is up to DTCSQ (DNSRT's Quality of Service component, the subject of U.S. patent application Ser. No. 12/508,952) to determine whether this is sufficient to satisfy the demands of the particular traffic that will be traversing that route.

Topology Discovery

DTCSR/TD includes mapping the AACs and the associated A/N IDs. Executing the MARS process produces this information. The local (N1) topology discovery for a given A/N is a DNSRT function that is reused by DTCSR if the present invention. The network-level topology discovery is created by DTCSR from the advertisement of local topologies across the network as previously discussed.

Route Control

DTCSR/RC may be defined as the routing component responsible for the following:
Initializing the routing parameters and tables in each A/N
Leading the processing and generation of routing messages
Directly commanding A/Ns to change normal operations for at least a short period of time
Coordinating the routing with other DNSRT services
Controlling and managing the dynamically-changing routing control channel set
Processing various routing error conditions
Providing interface control between its DTCSR service and other DTCSR networking services hosted at the same A/N
Providing interface control between its DTCSR service and other networking services hosted on other DTSRT A/Ns
Providing interface control between its DTCSR service and networking services on non-DNSRT networks

Although every DTCSR component may operate asynchronously according to the dynamics of the network, an explicit control function may be split out to ensure that all control is brought underneath a single function that can act as the conductor of the routing activity of a given A/N. This enables an improved overall operation especially when interacting with other A/Ns, other networks and other DNSRT services such as QoS, Security and Mobility Management.

One item of particular interest is the control and management of the routing control and management channel set. DTCSR/RC may use whatever mechanisms are permitted by the system architects. These may include only being given a specifically-designated set of control channels out of the universe of allowable channels and fixing the permanency of each member to be the same. Alternatively, some members may have an unlimited lifetime (e.g., “FOREVER,” or the lifetime of the network) while the others may have shorter membership lifetimes. Additionally, the instructions to DTCSR/RC for setting the membership of the routing control and management channel set may originate from sources such as, but not limited to, the CNR & Network Service Knowledge Base, fixed in the loaded executable program memory, messages passed during communication of other DNSRT control components (routing, security, network management, etc) within the same A/N or between A/Ns, or even interactively from a human interface point in the network.

Neighbor Discovery

In one embodiment, the method of DTCSR neighbor discovery is accomplished at the PHY and MAC Layers by using the link sensing and neighbor discovery scheme of the native RF devices. For example, some radios send out a preamble at a very high rate and get back the device IDs and AACs for each RF device. This signals to the originating RF device a list of its neighbors and hence, neighbor discovery. Therefore, neighbor information includes both node IDs plus the AAC set of each neighbor.

However, not all transmitting RF devices send out PHY Layer preambles. Therefore, DTCSR supports the periodic transmission of explicit Hello messages by any RF device advertising both its device ID (IP address, physical address, other) and AACs.

For an individual node, either a high enough SNR of the RF between the node and its neighbor node or the detection of other node-specific signal features will indicate the presence of a neighbor node. If associations are in the neighborhood, then a high enough SNR of the RF between the A/N and the leader node of other associations indicates the presence of a neighbor association.

Each A/N keeps a local record (information base) of all its N1s to include both individual nodes and associations. Additionally for the A/N, all of its N2s, MARS entities (a subset of the N1s and N2s) and the electorate for the given A/N are added to the A/N's local information base. This “electorate” refers to those A/Ns that have elected the given A/N as a MARS entity. The records may be empty for any of these fields in the local information base. In general, the content of this information base changes over time.

Routing Operations With Associations

DNSRT associations are a generalized extension of a single network node. An association could be thought of as a single node with multiple transmitters and multiple receivers operating either independently from or in concert with each other. An association may also be viewed as multiple nodes (in the traditional sense) that are strongly bound to each other by some type of relationship.

A multicast group may be defined as a special type of association, but by no means the only type. In a multicast group, one node is elected or appointed to be the leader (header) node and acts as the gateway from all other nodes in the group to other nodes outside of the group for managing the multicast group. The multicast group is comparable to a point-to-multipoint (PTM) networking scheme, but could be much more dynamic with the “point” in the PTM changing to a different node at times and group membership changing—especially in a MANET.

Another association type involves a group of nodes that do not actually all communicate with each other or the association's header node. Some of these nodes may be kept in reserve for redundancy reasons just in case they need to be called upon to step in for other nodes in the association that fail or become overloaded. These reserve nodes may only come into play at a certain time and may have much more limited transmission power or reception sensitivities. These scenarios, while possible to handle without the association construct, would be become more difficult to handle at the networking level. Therefore, just as in the case of a multicast group, an association can be viewed as a way to efficiently manage the networking for groups of nodes within the overall network that have a definite and useful common bond.

### Protocols

The DNSRT network of the present invention implements protocols associated with its functioning and configuration. The following list includes some of the protocols along with a description of what they are generally tasked to do:
DNSRT Initialization Protocol (DILP)—This protocol is associated with initial configuration and activation of the DNSRT network including initially configuring each DNSRT plus any other attached devices such as non-DNSRT gateways. Information used for initializing the network may include decision metrics, decision parameters, preconfigured routes (static or dynamic), node addresses, spectrum operating parameters, A/N metrics and parameters.
DNSRT MARS Control Protocol (DMCP)—DMCP is a protocol associated with handling MARS control in a DNSRT network. This protocol is responsible for issuing requests to one-hop neighbor A/Ns to collect and send their available spectrum information to the requesting A/N. The expected information to be received by the requestor includes a combination of the number of atomic channels along with contiguous channel maps. This protocol may also send out to other neighbor A/Ns the identities of the elected MARS A/Ns for that particular source A/N.
DNSRT Routing Control Protocol (DRCP)—DRCP is a routing master protocol associated with handling Routing Service control in a DNSRT network. This protocol is responsible for reserving/unreserving network resources, controlling the number of flows into areas of the network, setting bits in protocol headers governing QoS, etc.
DNSRT Routing Management Protocol (DRMP)—DRMP is a routing master protocol associated with handling Routing Service management in a DNSRT network. This protocol carries queries for monitoring the actual QoS performance through different devices and configures each device with the required QoS parameters such as the metrics for each class of service supported by a given device.

MANET is by nature highly cross-layer and network services such as routing directly tap into the cognitive networking radio device information (Physical Layer) in order to optimally route traffic over cognitive radios. If the network of CRs does not have DNSRT capability, then it will be very difficult or impossible for MANET routing, QoS and other network services to effectively operate in heterogeneous frequency topologies. This is even more pronounced in dynamic heterogeneous frequency topologies.

Metamorphic Nodes and the Local Spectrum Topology

A node with no DNSRT capabilities (e.g., node 25) is treated as external to the DNSRT network and would use at least one of the DNSRT nodes as a gateway into the DNSRT network. In one embodiment, the present invention requires each DNSRT node in the network to transform between remote and hub as the MANET reorganizes itself. This transformation—or metamorphosis—is initiated and executed under the direction and control of the local association of DNSRT nodes. The approach to forming an operational DNSRT network involves setting multi-association relays for spectrum (MARS). Embodiments of the invention show a straightforward path to dynamically electing the “hubs” responsible for coordinating and dispensing information about the local “spectrum topology” and any other type of network information such as quality of service (QoS). These hubs are also referred to herein as MARS set members. The present invention covers embodiments of single-node hubs and as well as generalized association hubs.

Reasoning on the Inputs

Once the expression of the selected knowledge has been decided and knowledge is being or has been collected, then it is necessary to process that knowledge so meaningful and correct outputs (decisions) are achieved. This processing may be referred to as “reasoning on the information.” Many reasoning engines exist such as used in classical expert systems, neural networks, genetic reasoning or fuzzy logic. In one embodiment, DNSRT's default is to use a fuzzy logic reasoning engine to assist with cognitive radio control and management. DNSRT's reasoning approach may be used to control and manage the actual radio or association of radios instead of the network that connects the radios. DTCSR may utilize networking schemes in concert with DNSRT's to effect the actual network.

DTCSR may also use crisp (opposite of fuzzy) logic to reason on its knowledge. This reasoning may be statistical or deterministic and may incorporate genetic reasoning. Temporal reasoning is used by DTCSR to reason on knowledge with temporal components. Therefore, while fuzzy logic may be used at the radio level for radio control and management, DTCSR may use the crisp outputs from DNSRT's reasoning, fuses this data with non-radio level statistical and/or non-fuzzy deterministic information, and then reasons on this knowledge in order to perform its routing service.

MANET/Mesh Routing, Flooding and Dynamic Spectrum Topology

MANET routing technology has a previously-developed protocol currently on track for IETF (Internet Engineering Task Force) standardization called Optimal Link State Routing (OLSR). In OLSR, an elected node, called a Multi-Point Relay (“MPR”), collects and distributes link state topology information using regularly-spaced Hello beacons. Hello beacons may be defined as periodic or aperiodic short transmissions from a node that let other nodes know the beacon-transmitting node is there. This link state topology information tells whether a link currently exists between given pairs of nodes in the local (one-hop) neighborhood of the MPR and in the two-hop neighborhood of the flooding source node. A flooding source node may be defined as the node which starts the flooding process. The flooding process may be defined as a service within a network to locate the receiver inside the network so that end-to-end communication can take place. As the network dynamics change the connectivity of a previously-connected local group of nodes, a new node is then elected as the MPR for those nodes at the two-hop distance from a given flooding source node. Hypothetically, every node in a MANET could be an MPR for some node that originates a flooding operation.

Applying OLSR or even MPR techniques to successfully operate a network of cognitive radios is not a workable solution.

First, OLSR is strictly a MANET routing protocol. Its only purpose is to efficiently route traffic of any type through the network using some subset of the MPRs as intermediate or destination nodes as needed. Regardless of any other type of traffic that is passed along routes involving MPRs, the connectivity of the network is regularly updated by monitoring neighbor beacons and flooded throughout the network over MPRs. OLSR has no mechanism for spectrum discovery, control or management, nor can it incorporate dynamic spectrum data from other sources into its routing decisions.

Second, a cognitive radio's primary concern is about the usability of spectrum in its neighborhood—not about the network connectivity to the nodes around it. That is, one cognitive radio could conceptually connect to another one, but may be prevented from doing so because either FCC or other government imposed regulations prevent interference with a primary user, or communications would be too degraded due to interference from another secondary user. Once the usability of the spectrum is established, network connectivity can then be addressed by whatever higher level protocols are in place—assuming they can work with a dynamically-changing frequency environment. This second reason is why neither MPRs nor OLSR are applicable to a network of cognitive radios. Since the FCC is very strict about secondary users interfering with primary users, this makes OLSR and other similar routing techniques and optimized flooding techniques such as MPR insufficient or even irrelevant for spectrum discovery and interference mitigation problems.

Correspondingly, trying to apply current CR available spectrum discovery, allocation and management techniques is also insufficient to help optimize the MANET (mesh) routing process. There is no routing functionality involved in this process. The need for providing a consistent, logical approach to bringing CR's main functionality (spectrum discovery and usage) together with MANET (or mesh) routing and other network services is driven by the fundamentally cross-layer nature of MANET or any other wireless network. This is even more critical for mobile wireless networks. DNSRT subsumes some facets of MANET routing, but is not performing any routing functionality. Some functionality that previously might have been incorrectly incorporated into routing are instead incorporated into the basic operation of the multichannel DNSRT platform.

This reallocation of routing functionality makes DTCSR simpler and focused on just the routing. MANET routing, including multicasting, is directly supported by the MARS election process. Much of the burden of route discovery is transferred from the routing service to (is subsumed by) the MARS election process, which is a natural part of the spectrum discovery and reuse functionality of the DNSRT CNR. Once a set of MARS A/Ns has been determined and provisioned for any given period time, traffic can be routed on a hop-by-hop basis. The actual status of routes and the management of them is performed by DTCSR and not by the DNSRT spectrum reuse method.

DTCSR uses whatever set of MARS entities are available at any given step in its routing process. Specifically, DTCSR utilizes one or more elements in this set to disseminate routing control messages and to request information from the network such as its non-interfering whitespace/grayspace spectrum-compatible neighbors, the QoS along various links, priority of a user request, battery status of nodes or security access over a link or through a A/N.

DTCSR uses the MARS set obtained via the network's underlying DNSRT capabilities to optimally flood the network with the next hop in a route. This does not necessarily mean that the next hop in any given route is just any member of an A/N's local MARS set. It means that the next hop in the route comes from one member of the A/N's local MARS set if only creating single routes from source to destination. More than one member of the A/N's local MARS set might be used if creating more than one route from the source to the destination. DTCSR allows either scenario.

Some of the routing functionality can be pushed down into a combination of PHY-MAC-Network cross-layer interaction. This has the effect of significantly speeding up or even making possible, the routing and general dissemination of information within the CNR network.

Cross-Layer Networking

MANET and other types of wireless mobile networks rely on cross-layer communications, a departure from the traditional communication flow up and down the OSI and TCP/IP stacks. Routing in a MANET will not work without routing algorithms tapping into such device-specific (Physical Layer) information as antenna coverage properties, mobility of the node, node battery power capacity, utilization rate and recharge rate. This implies that for optimal or even minimal performance, network services such as routing, QoS, mobility management, network management and security are required to interact directly with the radio at the PHY and lower MAC Layers.

For example, it is now well-known in MANET routing that in order to improve the probability of choosing “longer term” stable routes involving nodes with batteries, it is necessary to consider the battery charge capacity and remaining charge in the battery. Otherwise, routes with solid links between the nodes, but with some nodes running out of power too early, could be chosen to carry high-priority and long-duration traffic. In such a situation, if the network management service had already provisioned its remaining available subset of nodes for other users, there might not be enough time to quickly reprovision these other nodes in time to maintain the QoS agreed to in the service level agreement with that customer.

DTCSR has cross-layer connections to any functionality or data in the radio even at the low levels of the radio hardware. For example, it is now well-known in MANET routing that in order to improve the probability of choosing “longer term” stable routes involving nodes with batteries, it is necessary to consider the battery charge capacity and remaining charge in the battery. Otherwise, routes with strong links between the nodes, but with some nodes running out of power too early, could be chosen to carry high-priority and long-duration traffic. In such a situation, if the network management service had already provisioned its remaining available subset of nodes for other users, there might not be enough time to quickly reprovision these other nodes in time to maintain the QoS agreed to in the service level agreement with that customer.

In addition, routing will be required to interact with upper layers including the Application layer to incorporate information such as location of nodes and scheduled downtime of nodes. Cross-layering in DNSRT concerns itself with matters such as this and why the CNRs should incorporate this strategy into all future and even to some extent into existing radios to successfully form a CNR network. DTCSR uses the DNSRT mechanism for handling cross-layer information. This includes the transformation of information from one representation to another, for example, from numeric and vice versa. All requests for cross-layer information go to the DNSRT component to execute.

The DTCSR approach of the present invention makes use of the DNSRT spectrum discovery, which is part of the overall topology discovery component, and use/reuse capabilities to provide significant high performance routing. The DTCSR approach incorporates important routing parameters into a various metrics that the CNR then uses to choose the subset of channels from the local available universe to make available to network services tasks further up the stack.

One such key routing metric is called the “Homogeneous Channel Density (HCp)”. HCp is a route “goodness” metric and may be defined as (Number of same AACs)/(Number of AACs). HCp is calculated by averaging the number of times that the same AAC appears over a consecutive set of measurements and dividing this by the average number of times total AACs in each measurement over the same time period.

HCp ties routing closely to the PHY and MAC Layers as well as to the Network Layer. This metric helps to identify areas of the network that more likely to reliably be able to transport traffic than other areas. Additionally, with this area-level knowledge, it is not as important to optimize the choice of individual routes as to optimize the choice of the area of the network in which to route traffic through.

Cross-Layer Tactics for Routing

DTCSR applies methods for utilizing the spectrum reuse capabilities of DNSRT-enabled CNRs for communicating with individual or groups of other DNSRT-enabled CNR nodes (associations in general). Which ones of these to use can be established by setting policies in each A/N in the DNSRT network.

DNSRT supports variable single or multi-carrier preamble channels for A/N-to-A/N (inter-A/N) communications. This same capability enable efficient internal (intra)-A/N communications to occur while inter-A/N communications also take place. This enables flexibility for communications among A/Ns and also allows the preamble transmission power to be spread across more channels, thus lowering interference with other users with the preamble. The channels do not all have to be of the same bandwidth.

Negotiating Non-Interfering Frequency-Hopping Sequences Between Adjacent Ad Hoc Nodes and Associations

In accordance with the present invention, if a new ad hoc A/N of DNSRTs forms adjacent to another ad hoc A/N of DNSRTs, one of the following conditions may be imposed by the DTCSR network, depending on the commitment level of the source of the transmissions when trying to reach the intended destination (i.e., final recipient of the transmitted information).

1. Adjacent A/Ns are forced to be or automatically and dynamically determined to be forbidden to communicate with each other. The new A/N may likely have a new, negotiated orthogonal frequency-hopping sequence depending on the commitment level and the availability of a new space in the spectrum to which the new A/N can move, and/or

2. Adjacent A/Ns are forced to be, or are automatically and dynamically determined to be, forbidden to communicate with each other. The new A/N would autonomously migrate to unused space (withdraw from busy space).

3. Adjacent A/Ns are assumed to be, or are automatically and dynamically determined to be, allowed to communicate with each other. This third condition enables network connections to be established between adjacent A/Ns of cognitive radios such that adjacent A/Ns have communication frequencies in common with each other. The MARS election process described in this application may be used as a mechanism for supporting this frequency-hopping sequence determination selection.

These three commitment levels or conditions are not mutually exclusive. At least one of the first two configurations works closely together with the third in order for MANET or general mobile mesh networking to not only perform the usual networking functions and services, but also to meet stringent non-interference criteria such as, for example, that required by the FCC. The first two play significant roles when using the DNSRT spectrum reuse capabilities to limit the intermediate A/N routing choices using Physical Layer avoidance of the restricted frequencies (spectral non-interference). The third configuration comes into play after the allowable set of frequencies at the MARS or source A/N has been determined.

At the A/N level one of two things may occur.

1. At least one of the two A/Ns gives up at least one of its members (nodes) for the purpose of establishing an intermediate link from the source transmission to the intended destination(s) without interfering with the other nodes in the sacrificing A/N; or

2. One or more new nodes is added to one or both of the A/Ns that need to transfer information across that particular A/N. This may result in at least some A/Ns “carrying” auxiliary members for the purpose of maintaining communications across the A/N by non-A/N members without interfering with any of the main members of the A/N.

Assigning Local Frequency-Hoping Sequences

Somewhat similar to the classic four-color map problem, there is an issue with assigning frequency-hopping sequences to local (one-hop) A/Ns. The problem involves frequency reuse. It is mainly relevant if the hopping sequences are set, but unlike fixed-frequency cell networks, DNSRT can divide sequences into two or more sub-subsequences as needed for some period of time. This can prevent local neighbors of an A/N from interfering with the communications from the given A/N to a subset of its local neighbors and vice versa.

There are also other similarities to the four-color map problem. For example, if there are four QoS classes, these could behave more like fixed frequencies since they would have minimum bandwidth and latency requirements. Depending on the priority of the secondary user communications traffic, it is unlikely that the same set of frequencies (frequency hopping sequence) can remain constant as the traffic is routed from one node to the next through the MANET. This is because the radio would have to avoid interfering with primary users who are operating on different sets of frequencies separating the source and destination of any given communications.

The DNSRT of the present invention handles problems and issues surrounding the assignment of frequency-hopping sequences to one-hop neighbors of any given A/N. For example, the MARS A/Ns' local cognitive reasoning works to help traffic flow in its most optimal manner in connection with providing cross-layer information, as explained above. Also, a DNSRT may readily detect other DNSRTs within its range and map out the channels they are using.

Exchange of Whitespace/Grayspace Information Among Nodes and Associations

In one embodiment of the present invention, each A/N carries its own, independent interference data for that A/N, but also exchanges this data with adjacent A/Ns using the “Whitespace/Grayspace Exchange Protocol” (WGXP). Adjacent A/Ns may operate independently with respect to interference measurements. Some nodes or associations may be geographically common to two or more A/Ns and may migrate from one A/N to another, so it is desirable to report interference to adjacent A/Ns.

In one embodiment, adjacent A/Ns communicate for purposes of management (hopping sequences, interference measurement, device status, etc.) and application data passing. For example, a DNSRT common to both A/Ns can relay messages between A/Ns. Timing is a primary difficulty associated with this case. Both A/Ns operate independently so it is difficult for a common station to know when to listen on one A/N and when to ignore the other. It is also difficult for DNSRTs within an A/N to know when one of its corresponding DNSRT members is distracted (ice., involved in communication with) by another A/N.

The DNSRT of the present invention may address this timing problem in several ways. For example, DNSRTs may synchronize their TDMA MACs so that there are known times when transceivers listen elsewhere. This fundamentally involves aligning the time slots in each TDMA epoch. Alternatively, the DNSRTs may use GPS as a time reference to define times when messages can be exchanged between A/Ns.

The adjacent A/N communication may also be implemented by adding hooks for cognitive control and management to existing MANET routing methods, but without the full-blown routing functionality included. This makes the routing simpler and much more efficient by removing certain functionality from the MANET routing algorithms and placing it into radio control and management in the Physical and lower MAC Layers. This makes any routing method chosen simpler with a more complicated, but more efficient, Physical and lower MAC Layer capability. Simplification of neighbor discovery and qualification of the neighbor as a node (A/N) in a route from the given source to the given destination is one such capability pushed down below the Network (Internet) Layer.

The cross-layer nature of DNSRT may require the routing service to gather data and knowledge (information) from any network stack layer, fuse the information, and then control the innermost parts of the routing algorithm to properly respond to the events captured in the information. This may require reaching into the kernel of the DTCSR algorithm in order to wrest control over how it responds to events. DTCSR builds upon DNSRT's fundamental spectrum reuse approach and adds the kernel level hooks for cross-layer routing control and information input. DNSRT may use daemons as its default implementation approach to update and maintain its kernel-level tables and status.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for optimization of routing in a wireless network of cognitive network radios comprising:
receiving routing input parameters from a crosslayer interface;
creating additional parameters from received parameters;
processing said received and additional parameters using a knowledge mapping and reasoning engine;
utilizing numeric or linguistic results for targeted routing operations;
if updated information is created, updating a routing knowledge database; and
sending relevant routing information to a route controller.
